(19) United States
(12) Patent Application Publication
(10) Pub. No.: US 2009/0026049 A1
(43) Pub. Date: Jan. 29, 2009

(54) Device for monitoring the flow rate of a medium in a continuous flow device

(75) Inventor: Frank Trinter, Kaufungen (DE)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: SIKA Dr. Siebert & Kuhn GmbH & Co. KG, Kaufungen (DE)

(21) Appl. No.: 12/077,710

(22) Filed: Mar. 20, 2008

(30) Foreign Application Priority Data
Jul. 28, 2007 (EP) 07014851.5-1234

(51) Int. Cl. H01H 35/40

(52) U.S. Cl. 200/81.9 M

(57) ABSTRACT

The subject matter of the present invention is a device for monitoring the flow rate of a medium in a continuous flow device such as a tube, a water distribution system, a heating boiler or the like, comprising a paddle pivotally mounted in a housing and comprising at its end a paddle blade that projects into the flow of the continuous flow device, the paddle's pole (11) comprising two opposing axle journals (25) that are rotatably receivable in the housing (2), said paddle's pole (11) being adapted to be introduced into said housing and the axle journals (25) being adapted to be snap-fit into bearing bushings (3), said paddle's pole (11) being elastically deformable in the region of the axle journals (25) in the direction of the longitudinal axis of the axle journals by the fact that the paddle's pole (11) comprises a slot-like opening (24) in the region of the axle journals.

### FIELD OF THE INVENTION

The present invention relates to a device for monitoring the flow rate of a medium in a continuous flow device such as a tube, a water distribution system, a heating boiler or the like, comprising a paddle pivotally mounted in a housing and comprising at its end a paddle blade that projects into the flow of the continuous flow device, the paddle's pole comprising two opposing axle journals that are rotatably receivable in the housing.

Such a device for monitoring the flow rate of a medium, in short called flow control switch or flow guard, includes—as already mentioned—a paddle, said paddle, when being deflected from its initial position, triggering a signal indicating the presence of a flow. Usually, there is provided that the paddle possesses at its end a magnet that cooperates for example with a corresponding reed contact. The function of such a flow control switch is to enable a corresponding switching operation when the flow rate falls below or exceeds a previously determined flow rate. For this purpose, the paddle of the control switch projects into the medium, the paddle pivotally disposed in the housing being deflected in accordance with the respective flow rate.

### DESCRIPTION OF THE PRIOR ART

Such a flow control switch is well known in the art. In this context, the reader is referred to the German Patent 38 01 770 C2 for example. The various parts of such a flow control switch are usually injection-molded plastic parts that only need to be assembled.

A flow control switch of the type mentioned herein above is known from U.S. Pat. No. 6,548,775 B1. The paddle has lateral arms with axle journals disposed at their ends that are rotatably receivable through a corresponding passageway in the housing of the switch. In order to facilitate the introduction of the axle journals into the corresponding passageways, the housing comprises an inclined stop in the region of a respective one of the passageways. However, assembly is complex. Since the housing is deformed when the axle journal snap-fits into the respective passageway, the axle journals risk to break during mounting.

Flow control switches are subjected to considerable pricing pressure, in particular because these flow control switches are essentially manufactured in the Far East. In particular during assembly of the various parts of such a flow control switch, quite a lot of time is spent on fastening the paddle in the housing.

### BRIEF SUMMARY OF THE INVENTION

It is the object of the invention to simplify the mounting of the paddle in the housing, this, against the background of minimizing the assembly time in order to make manufacturing of such a flow control switch less expensive.

As a solution to this object, the invention proposes that the paddle's pole be elastically received in the region of the axle journal in the direction of the longitudinal axis of the axle journals by the fact that the paddle's pole comprises a slot-like opening in the region of the axle journals. The mounting of the paddle in the housing is easy since the paddle's pole is pinched between thumb and index finger thus being deformed in such a manner that the axle journals may be readily brought into their seats in the housing. If the pressure onto the paddle's pole is minimized, the two axle journals are snap-fit into their corresponding bearings.

The width of the slot is thereby chosen for the paddle's pole to be inserted into the housing together with the axle journals when the legs of the slotted paddle's pole abut on each other. For rotatably receiving the axle journals, the housing possesses corresponding bearing bushes which, in the simplest case, constitute openings in the housing.

The invention will be understood better upon reading the exemplary description accompanying the drawing wherein:

### BRIEF DESCRIPTION OF THE DRAWING

FIG. 1 shows the flow control switch, including the housing and the paddle accommodated in the housing;

FIG. 2 shows the paddle.

### DETAILED DESCRIPTION OF THE INVENTION

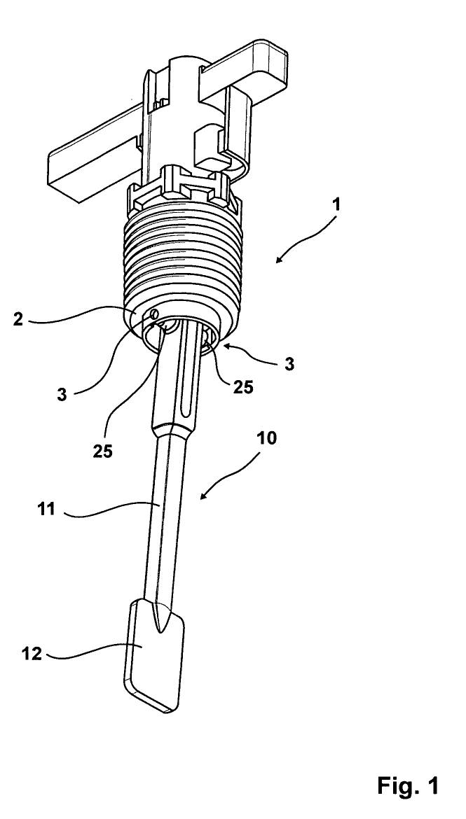

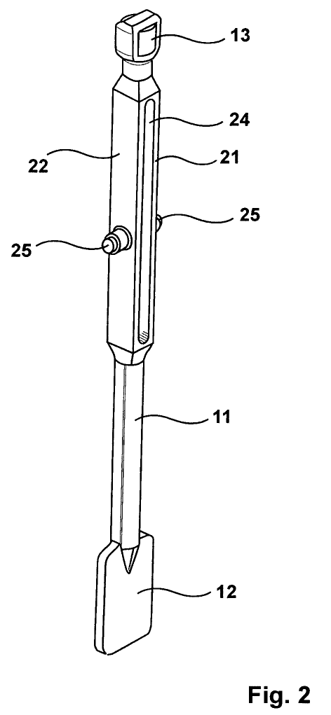

The flow control switch indicated generally at 1 includes the housing 2 as well as the paddle, indicated generally at 10. The housing 2 includes two bearing bushings 3 that are oppositely disposed from each other in the housing 2. The paddle 10 (FIG. 2) includes a paddle pole 11, the paddle blade 12 as well as the magnet 13 disposed at the end of the paddle pole. The paddle pole 11 possesses a portion 21 within which the paddle pole is divided by a slot 24 and forms two legs 22, 23. On the outer face of the legs 22, 23 there are located the two axle journals 25 for reception by the bearing bushing 3 of the housing 2. Pressure exerted onto the two legs 21, 22, such as with the thumb and the index finger, causes the legs to be deformed to such an extent that the paddle pole may be introduced into the housing 2 together with the axle journals 25 (see FIG. 1); then, the axle journals are capable of being snap-fit into the bearing bushings 3 which, in the present case, constitute openings in the housing. It is obvious that this allows for considerably minimizing the time needed for mounting a flow control switch.

I claim:

1. A device for monitoring the flow rate of a medium in a continuous flow device such as a tube, a water distribution system, a heating boiler or the like, comprising a paddle pivotally mounted in a housing and comprising at its end a paddle blade that projects into the flow of the continuous flow device, the paddle's pole (11) comprising two opposing axle journals (25) that are rotatably receivable in the housing (2), said paddle's pole (11) being adapted to be introduced into said housing and the axle journals (25) being adapted to be snap-fit into bearing bushings (3), characterized in that the paddle's pole (11) is elastically deformable in the region of the axle journals (25) in the direction of the longitudinal axis of the axle journals by the fact that the paddle's pole (11) comprises a slot-like opening (24) in the region of the axle journals.
